(19) United States
(12) Patent Application Publication
(10) Pub. No.: US 2008/0155284 A1
(43) Pub. Date: Jun. 26, 2008

(54) Power consumption adjusting apparatus and processing method

(75) Inventors: Kazutoshi Shimohata, Kawasaki (JP); Yasuhiro Hirano, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/987,396

(22) Filed: Nov. 29, 2007

(30) Foreign Application Priority Data
Dec. 25, 2006 (JP) 2006-347129

(51) Int. Cl. G06F 1/26

(52) U.S. Cl. 713/300

(57) ABSTRACT

An apparatus measures a dynamic power consumption in each of component devices at a time intervals and subtracts the sum of the dynamic power consumptions from a predetermined maximum value to obtain a dynamic margin. When a request for connecting an emergency device to a power supply is issued, the apparatus compares the rated power consumption in the emergency device with the dynamic margin. If the rated power consumption in the emergency device exceeds the dynamic margin, the apparatus selects, as a disconnectable device, a component device having an individual margin calculated by subtracting the dynamic power consumption from the rated power consumption is greater than an excess of power amount over the dynamic margin of the rated power consumption in the emergency device and the lowest priority. The apparatus issues an instruction to power the emergency device if the rated power consumption in the emergency device is less than or equal to the dynamic margin, issues an instruction to power off the disconnectable device if the rated power consumption in the emergency device exceeds the dynamic margin, and issues an instruction to power on the emergency device after the power-off of the disconnectable device is confirmed.

### CROSS-REFERENCE TO RELATED APPLICATIONS

This application claims priority from Japanese patent application Serial no. 2006-347129 filed Dec. 25, 2006, the contents of which are incorporated by reference herein.

### BACKGROUND OF THE INVENTION

1. Field of the Invention

The present invention relates to a system which adjusts a power consumption in computer system equipment in a data center (hereinafter simply referred to as the “center”) including multiple computer systems. In particular, the present invention relates to a program for causing a computer to perform power consumption adjustment processing when an additional terminal device such as a device for an emergency task is to be attached in a center that operates a regular business system such as an account service system, and to an apparatus which performs such processing.

2. Description of the Related Art

A power supply design for a center including multiple computer systems for constantly operating a system for regular tasks such as account service tasks calculates the maximum value of power consumption in equipment used in steady operation on the basis of the rated power consumptions of component devices of the systems and the like and uses the maximum value adding some margin of power supply. In a design phase, it is emphasized to supply power for regular operation.

As an approach to adjusting power consumption among peer computer systems interconnected through a network, Patent Document 1 (Japanese Patent Laid-Open No. 2006-11793) discloses a system that adjusts the power amount of electric power supplied to each compute system when only a predetermined limited power amount is supplied.

However, the amount of power supply to equipment for irregular tasks, such as maintenance service tasks and equipment operation checking tasks, in the center has not been given due consideration in designing because the timing of such tasks and time required for the tasks are difficult to estimate.

Consequently, it has been sometimes impossible to immediately power on a device provided for an irregular task when a power consumption in regular tasks is approaching a limit, because an additional power consumption for the irregular task can riskily increase the amount of power supply in the entire center to the limit.

If it is impossible to quickly and appropriately determine the power supply capacity required for safely powering on an additional device, the limit value of power supply can be exceeded and system down can be caused by an interruption in power supply.

If power supply is tight when an emergency maintenance task is to be performed, some of devices in the system in constantly operation must be temporarily shut down. However, determination that which of devices and how many devices should be turned power off has been made on the basis of empirical rules. Accordingly, there have been problems that a sufficient margin of power supply cannot be obtained by powering off and that it takes too much time to supply a sufficient amount of power. The problems affect steady business operations.

Therefore, it is required a technique which enables power consumption in an entire center to be adjusted so that irregular tasks can be immediately performed within the limits of power supply to the entire center, regardless of power consumption of a system in regular operation.

### SUMMARY OF THE INVENTION

An object of the present invention is to provide a program for causing a computer to perform power consumption adjustment processing capable of adjusting power consumptions of steady operation of systems in a center so that a terminal device for an irregular task such as emergency maintenance can be powered on in the center and to provide an apparatus that performs the power consumption adjustment processing.

The present invention provides a program that, in order to adjust a power consumption in constantly operated computer system equipment, causes a computer to function as an apparatus providing processing unit for executing the following processing.

A computer according to the present invention stores rated power consumptions of component devices of a computer system in a center and of an emergency device for an irregular task in the center and power supply priorities of the component devices. The computer measures a dynamic power consumption in each component device at predetermined time intervals. The computer subtracts the sum of dynamic power consumptions from a maximum value set as a maximum power amount allowed to be consumed in the center in order to obtain a dynamic margin at the time intervals. When power-on of the emergency device is requested, the rated power consumption in the emergency device is compared with the dynamic margin. If the rated power consumption in the emergency device exceeds the dynamic margin, a component device is selected as a disconnectable device that has an individual dynamic margin, which is a remainder subtracted a dynamic power consumption from the rated power consumption, is greater than an excess amount of power which exceeds the dynamic margin generated from the rated power consumption in the emergency device and that has the lowest in the priorities among the component devices. If the rated power consumption in the emergency device is less than or equal to the dynamic margin, an instruction to power on the emergency device is issued; if the rated power consumption in the emergency device exceeds the dynamic margin, an instruction to power off the disconnectable device is issued. After it is confirmed that the disconnectable device has been powered off, an instruction to power on the emergency device is issued.

In this way, a dynamic margin, which is the difference between a predetermined maximum value and an actual power consumption, is calculated at predetermined time intervals. Determination is made on the basis of the dynamic margin as to whether or not a device for which power-on is requested should be powered on. If the margin of power supply is insufficient, a component device having a lower priority is powered off so that the emergency device can be powered on. Thus, when an emergency task needs to be performed while component devices of the computer system are operated at power consumptions near the maximum of possible power supply, a component device can be appropriately powered off based on the power consumption at the time point to ensure the amount of power supply required for the emergency device so as not to affect the steady operation of regular business services.

Furthermore, when there is a powered-off component device, the computer according to the present invention compares a dynamic margin which is a remainder by subtracting the sum of the dynamic power consumptions of the component devices measured at a predetermined timing subtracted from the maximum value with a rated power consumption in the component device in the power-off state. Then, the computer selects a component device in the power-off state that has a rated power consumption less than or equal to the dynamic margin and has the highest priority, and sends an instruction to power on the selected component device.

Thus, when the dynamic margin of the entire computer system becomes large enough to satisfy the rated power consumption in a component device in the power-off state, a component device which was connected to a power supply can be immediately powered on again.

When the priorities are represented by a power amount, the computer according to the present invention subtracts the difference between the rated power consumption in a component device and the dynamic power consumption from the priority of the component device to obtain a dynamic priority of the component device, and uses the dynamic priority, instead of the former priority, to identify the disconnectable device.

Generally, a component device that has a larger individual dynamic margin (rated power consumption -(minus) dynamic power consumption) is operating at a lower utilization rate and therefore power-off of the device may have a less effect on constantly operation. Therefore, by relatively decreasing the priorities of devices having large individual dynamic margins, a disconnectable device can be selected in accordance with an actual operational status and power consumption can be adjusted more appropriately and smoothly.

The present invention provides an apparatus including processing unit that performs the power adjustment processing described above and a processing method for causing a computer to perform the power consumption adjustment processing.

A computer program implementing the present invention can be stored on an appropriate recording medium such as a computer-readable removable memory, a semiconductor memory or a hard disk, and is recorded and distributed on such a recording medium or is distributed by transmitting and receiving via a communication interface through any of various kinds of communication networks.

According to the present invention, the power consumptions of component devices of a computer system in a center that steadily operates a system for business services such as account service tasks are measured at a predetermined timing and, if the power consumption in a device for an irregular task such as emergency maintenance cannot be covered within a dynamic margin of power supply, a component device that has a lower power supply priority is selected and powered off so that the device for the emergency maintenance can be powered on. Thus, an emergency task can be immediately performed without affecting steady operation of the regular business system in the center and the power consumption in the center can be adjusted smoothly and appropriately.

### BRIEF DESCRIPTION OF THE DRAWINGS

FIG. 1 shows an exemplary configuration of a data center in which the present invention is implemented.

FIG. 2 shows an exemplary configuration of data in an adjustment management table.

FIGS. 3A and B show exemplary configurations of data in a rated power consumption table and an equipment management table 120.

FIGS. 4A and B are diagram illustrating a dynamic margin.

FIG. 5 shows a flow of power adjustment processing.

FIG. 6 shows a flow of restore adjustment processing.

### DETAILED DESCRIPTION OF THE PREFERRED EMBODIMENTS

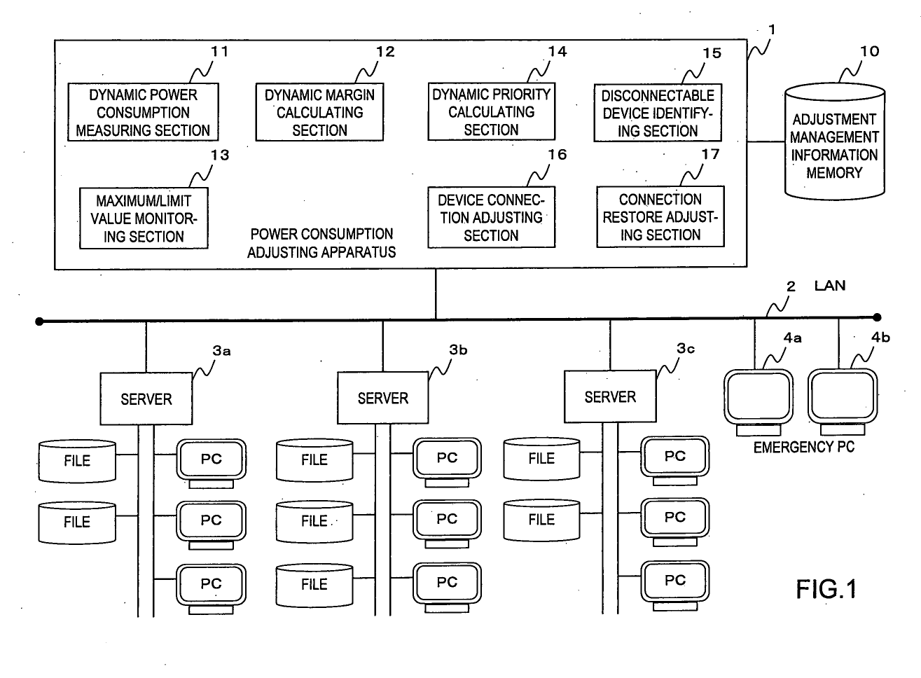

FIG. 1 shows an exemplary configuration of a data center in which the present invention is implemented.

The center is equipped with a power consumption adjusting apparatus 1, servers 3a, 3b, 3c, . . . , and computers (emergency PCs) 4a, 4b, . . . , which are interconnected through a LAN 2. It is assumed here that the data center includes three servers 3a, 3b, and 3c and two emergency PCs 4a and 4b.

The power consumption adjusting apparatus 1 adjusts power consumptions of devices constituting the servers 3a, 3b, and 3c provided in the center.

Each of the servers 3a, 3b, and 3c includes file devices and computers (PCs) and the like and constitutes a sub-system that constantly performs account service tasks. The devices constituting the servers 3a, 3b, and 3c can be independently powered on and off.

The emergency PCs 4a and 4b perform irregular tasks such as maintenance services of the servers 3a, 3b, and 3c. The emergency PCs 4a and 4b are normally in the power-off state and are powered on only when the irregular tasks are to be performed.

The power consumption adjusting apparatus 1 includes an adjustment management information memory 10, a dynamic power consumption measuring unit 11, a dynamic margin calculating unit 12, a maximum/limit value monitoring unit 13, a dynamic priority calculating unit 14, a disconnectable device identifying unit 15, a device connection adjusting unit 16, and a connection restore adjusting unit 17.

The adjustment management information memory 10 stores an adjustment management table 100, a rated power consumption table 110, and an equipment management table 120.

The adjustment management table 100 contains rated power consumption values of the devices constituting the servers 3a, 3b, and 3c and the emergency PCs 4a and 4b provided in the center and initial power supply priorities of the devices, disconnection rejection information (rejection flag) indicating a component device that is to be excluded from power adjustment, and information indicating device to be included in power adjustment.

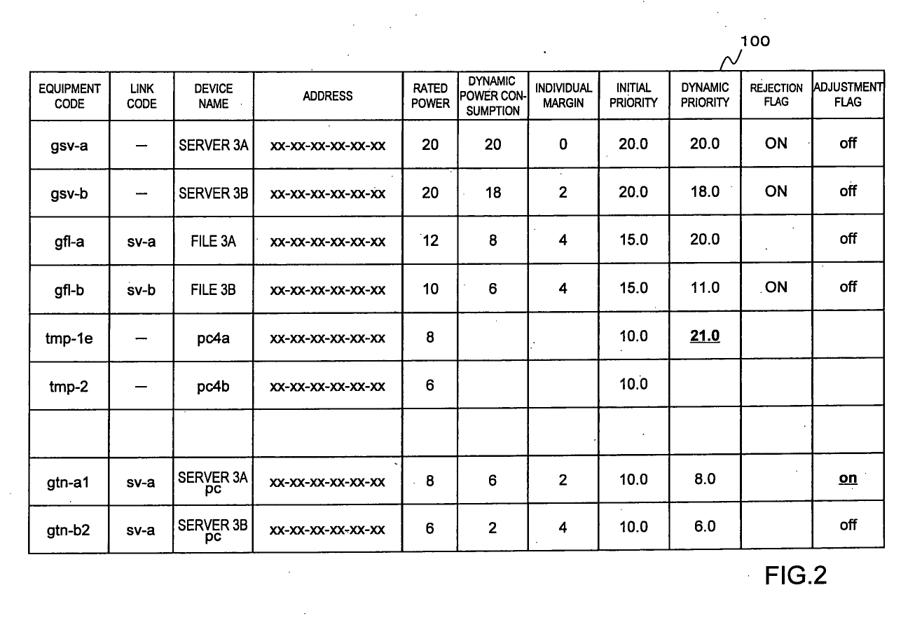

FIG. 2 shows an exemplary data configuration of the adjustment management table 100. The adjustment management table 100 contains data items, including equipment code, link code, device name, address, rated power, dynamic power consumption, individual margin, initial priority, dynamic priority, rejection flag, and adjustment flag.

“Equipment code” indicates the equipment type of a device in a system configuration and uniquely identifies the device. For example, “gsv-” in “gsv-a” indicates an account service server and “a” indicates the server 3a, “gf1-” indicates a file device, “gtn-” indicates a computer (PC) connected to the servers 3a, 3b, or 3c, and “tmp-” indicates an emergency PC.

“Link code” indicates the server to which a device is connected. For example, “sv-a” indicates that the device is connected to the server 3a. “Device name” is the name of a physical device. “Address” is address information used for transmitting a predetermined instruction or request. For example, a MAC address or a device address may be used. “Rated power” represents the rated power consumption, which indicates the designed maximum allowable power consumption in a device. “Dynamic power consumption” represents the actual power consumption in a device measured at a predetermined timing.

“Individual margin” represents a value calculated by subtracting the dynamic power consumption from the rated power consumption (rated power) of a device. “Initial priority” indicates a preset power supply priority of a device. In the present embodiment, the initial priority is represented by a power amount. “Dynamic priority” represents a value calculated by subtracting an individual margin from an initial priority value. If the subtraction yields a negative value, the value is set as the initial priority.

“Rejection flag” represents flag information indicating that a device is to be excluded from adjustment. The rejection flag of a device is set to “ON” if the device cannot be powered off for system configuration reasons. For example, a server is a key device in business processing and, when powered off, the system will be down. Therefore the rejection flag of a server is set to “ON”. On the other hand, the rejection flag of a device such as a display device or switching device is not set to “ON” and the device is set as a disconnectable device because the system does not go down when the device is powered off.

“Adjustment flag” is flag information indicating whether a device is disconnectable (on) or not (off). The adjustment flag of a device selected as a disconnectable device is turned “on”.

In the present embodiment, a physical device or a group of physical devices indicated by an equipment code in the adjustment management table 100 in FIG. 2 can be disconnectable as a unit.

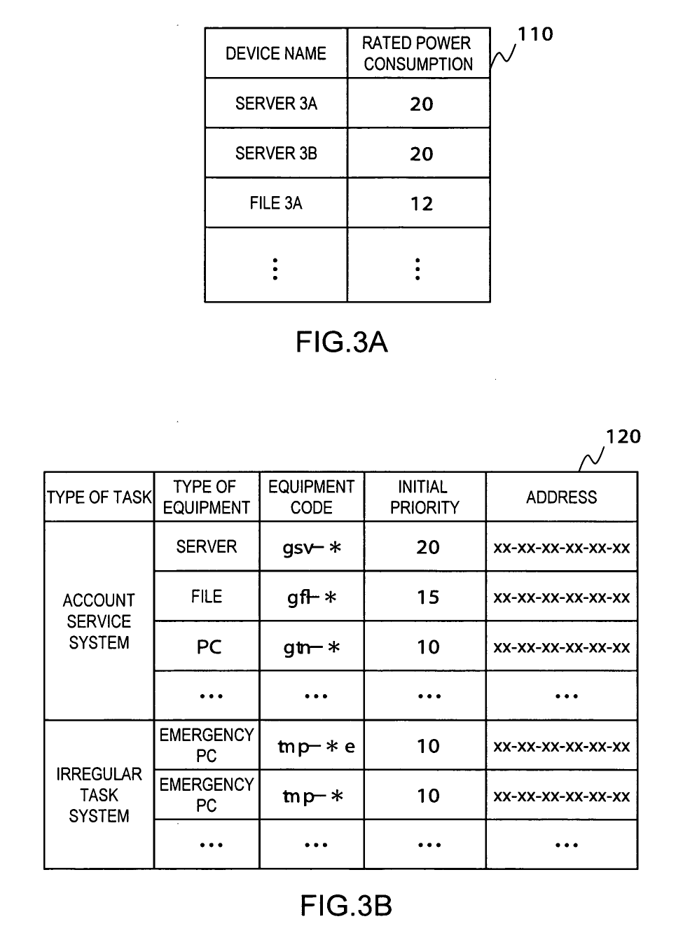

FIGS. 3A and 3B show exemplary data configurations of the rated power consumption table 110 and the equipment management table 120. The rated power consumption table 110 in FIG. 3A contains the rated power consumption values of devices (component devices of the servers 3a, 3b, and 3c and emergency PCs 4a and 4b) that can be connected to the power supply of the center.

The equipment management table 120 in FIG. 3B contains information about an equipment configuration of a regular business system such as an account service business system (servers 3a, 3b, and 3c) and an equipment configuration used for irregular tasks such as emergency maintenance (emergency PCs 4a and 4b), the types of the equipment, equipment codes, initial priorities, and addresses.

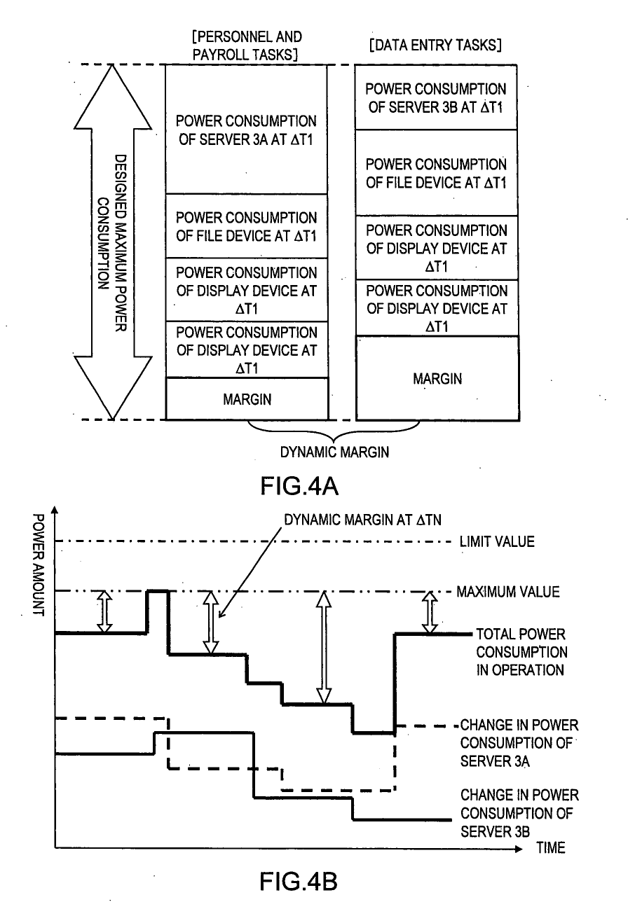

The dynamic margin will be described with reference to FIGS. 4A and 4B.

FIG. 4A shows the relationship between a designed maximum power consumption and dynamic margin. It is assumed here that personnel and payroll tasks are steadily performed on the server 3a in the center and data entry tasks are constantly performed on the server 3b. The dynamic power consumption measuring unit 11 measures a power consumption in each component device of the servers 3a and 3b at a time point Δt, for example at time intervals of 5 to 15 minutes. If the maximum value is set to the sum of the rated power consumptions of the component devices of the servers 3a and 3b, the dynamic margin at the time point Δt is obtained from a remainder by subtracting the sum of the dynamic power consumptions of the serves 3a and 3b measured by the dynamic power consumption measuring unit 11 from the maximum value.

The individual margin of the device is found by subtracting the dynamic power consumption in the device from the rated power consumption in each device.

FIG. 4B shows an example of changes in power consumptions of the servers 3a and 3b at predetermined time intervals. The power consumption in each device changes depending on the amount of data processing in the server, the amounts of data read and write on the file device, the brightness of the display device, and the like. When a request for connecting to a power supply is issued from the emergency PC 4a (or 4b), determination is made on the basis of the dynamic margin calculated from the sum of the dynamic power consumptions measured at a timing Δtn immediately before the connection request as to whether the rated power consumption in the emergency PC 4a can be satisfied.

The dynamic power consumption measuring unit 11 of the power consumption adjusting apparatus 1 measures the dynamic power consumption in each component device of the servers 3a, 3b, and 3c at predetermined timings and write the measured dynamic power consumptions in the adjustment management table 100.

The dynamic margin calculating unit 12 subtracts the dynamic power consumption in each device in the adjustment management table 100 from its rated power consumption in obtain an individual margin and writes it in the adjustment table 100.

The maximum/limit value monitoring unit 13 stores a preset maximum power consumption (maximum value) and a power consumption limit (limit value) and, when a device requests for connection to the power supply (connection requesting device), calculates the sum of the dynamic power consumptions of the devices set in the adjustment management table 100 and determines whether the sum plus the rated power consumption in the connection requesting device exceeds the maximum value or the limit value.

Here, the maximum value is the sum of the rated power consumptions of the devices that constitute the servers 3a, 3b, and 3c in the center and can be connected to the power supply. The limit value is a value that does not exceeds the actual amount of power supplied by the power supply equipment of the center and is greater than the maximum value by n %. The limit value is set in order to avoid a physical impact to the power supply equipment.

The dynamic priority calculating unit 14 subtracts the individual margin of each device in the adjustment management table 100 from its initial priority value to obtain a dynamic priority value and writes it in the adjustment management table 100.

When receiving a power connection request from a device that is not currently connected to the power supply, the disconnectable device identifying unit 15 adds the rated power consumption in the device requesting the connection (connection requesting device) to the sum of the dynamic power consumptions of all devices in the connection management table 100. If the rated power consumption in the connection requesting device exceeds the dynamic margin which is the sum of the individual margins, the disconnectable device identifying unit 15 selects as a disconnectable device a device that has an individual margin greater than the power amount by which the rated power consumption in the connection requesting device exceeds the dynamic margin and has the lowest initial or dynamic priority. Details of the power adjustment processing will be described later.

The device connection adjusting unit 16 receives a power supply connection request from a device that is not currently connected to the power supply and notifies the disconnectable device identifying unit 15 of the request. The device connection adjusting unit 16 also sends an instruction to power off the disconnectable device selected by the disconnectable device identifying unit 15 and, after verifying the power-off of the disconnectable device, sends an instruction to power on the connection requesting device.

If there is a disconnectable device that is in the power-off state, the connection restore adjusting unit 17 determines whether the dynamic margin of the device in the adjustment management table 100 at a predetermined timing exceeds the rated power consumption in the disconnectable device. If the dynamic margin is greater than or equal to the rated power consumption in the disconnectable device, the connection restore adjusting unit 17 sends an instruction to power on the disconnectable device to restore connection of the device to the power supply. The connection restore processing will be detailed later.

A flow of processing according to the present invention will be described next.

The dynamic power consumption measuring unit 11 measures the dynamic power consumptions of the servers 3a, 3b, and 3c at the predetermined time point Δt and writes them in the adjustment management table 100. The dynamic margin calculating unit 12 calculates the individual margin of each device from the rated power consumption and dynamic power consumption in the device in the adjustment management table 100 and writes it in the adjustment management table 100. The dynamic priority calculating unit 14 subtracts the individual margin of each device in the adjustment management table 100 from the initial priority of the device to obtain a dynamic priority value and writes it in the adjustment management table 100. The processing described above is performed every time the dynamic power consumptions are updated at the predetermined time point Δt.

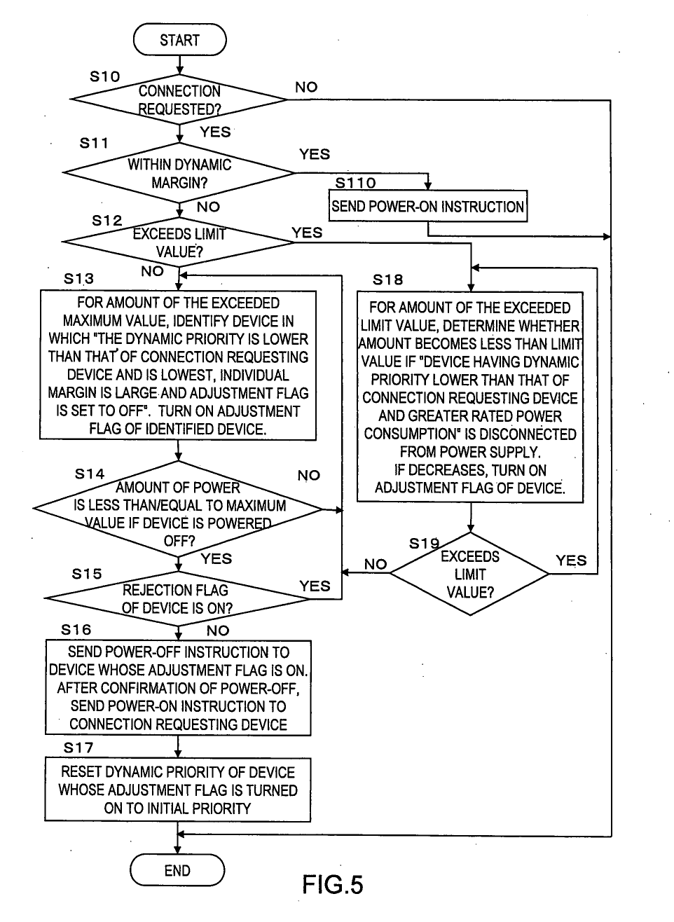

When a request for connecting to the power supply from a device is detected, the power adjustment processing is performed. A flow of the power adjustment processing is shown in FIG. 5.

Step S10: The device connection adjusting unit 16 detects a request for connecting to a power supply. The device connection adjusting unit 16 obtains information about the connection requesting device and adds the information to the adjustment management table 100. If the connection requesting device is to be added to the configuration of any of the currently operating servers 3a, 3b, and 3c, the device connection adjusting unit 16 obtains required information (for example the equipment code, address, and initial priority of the device) from the equipment management table 120 and adds the information to the adjustment management table 100.

On the other hand, if the connection requesting device is the emergency PC 4a, the device connection adjusting unit 16 prompts a user to input a predetermined character string (for example an emergency ID and password) and compares the input character string with predetermined information to determine whether the connection requesting device is an emergency terminal. If the device is an emergency terminal, the device connection adjusting unit 16 adds information about the connection requesting device (emergency PC 4a), for example the equipment code, link code, device name, and address to the adjustment management table 100. When the equipment code is set, a particular character “e” indicating that the device is an emergency terminal is added to the equipment code. A predetermined value that will be the maximum value among the values set in the initial priority column of the adjustment management table 100 is set. For example, the equipment code “tmp-1” of the emergency PC 4a in the adjustment management table 100 shown in FIG. 2 is changed to “tmp-1e” and, because the highest initial priority value is “20” in the original table, a greater value, for example “21” is set.

Information to be set in the adjustment management table 100 may be input from the connection requesting device itself or an administrator's terminal (not shown in FIG. 1).

Step S11: The maximum/limit value monitoring unit 13 determines whether the rated power consumption in the connection requesting device is within the dynamic margin. The maximum/limit value monitoring unit 13 refers to the adjustment management table 100 to obtain the dynamic margin at the predetermined time point Δt and determines whether the rated power consumption in the connection requesting device is within the dynamic margin. If the rated power consumption in the connection requesting device is within the dynamic margin, the maximum/limit value monitoring unit 13 determines that the connection requesting device can be powered on and the process proceeds to step S110. On the other hand, if the rated power consumption in the connection requesting device is not within the dynamic margin, the process proceeds to step S12.

Step S12: The maximum/limit value monitoring unit 13 adds the rated power consumption in the connection requesting device to the sum of the dynamic power consumptions at the time point Δt and determines whether the resulting power amount exceeds the limit value. If the resulting power amount does not exceed the limit value, the process proceeds to step S13. On the other hand, if the resulting power amount exceeds the limit value, the process proceeds to step S18.

Step S13: The disconnectable device identifying unit 15 selects as a disconnectable device a device that satisfies the conditions that “the individual margin is greater than or equal to the amount by which the rated power consumption in the connection requesting device exceeds the dynamic margin, the dynamic priority is lower than that of the connection requesting device, the dynamic priority is the lowest, and the adjustment flag is off”. Then, the disconnectable device identifying unit 15 sets the adjustment flag of the disconnectable device to “on”.

Step S14: The disconnectable device identifying unit 15 determines whether the power amount that will result if the disconnectable device is powered off, that is, the power amount calculated by subtracting the dynamic power consumption in the disconnectable device from the dynamic power consumption at the time point Δt is less than or equal to the maximum value. If the power amount is less than or equal to the maximum value, the process proceeds to step S15. On the other hand, if the power amount is greater than the maximum value, the process returns to step S13, where another device that satisfies the conditions given above is selected as a disconnectable device.

Step S15: The disconnectable device identifying unit 15 determines whether the rejection flag of the disconnectable device is set to ON. If the rejection flag is not set to ON, the process proceeds to step S16. If the rejection flag is set to ON, the adjustment flag of the disconnectable device is turned off and the process returns to step S13, where another device that satisfies the condition given above is selected as a disconnectable device.

Step S16: The device connection adjusting unit 16 refers to the adjustment management table 100 and sends an instruction to power off the disconnectable device (whose adjustment flag is ON). After confirming the power-off of the disconnectable device, the device connection adjusting unit 16 sends an instruction to power on the connection requesting device.

Step 17: The device connection adjusting unit 16 resets the dynamic priority of the disconnectable device to the initial priority. Then the process will end.

Step S18: The disconnectable device identifying unit 15 selects a device “that has the rated power consumption which is greater than the power amount by which the rated power consumption in the connection requesting device plus the sum of the dynamic power consumptions at the time point Δt exceeds the limit value and the dynamic priority which is lower than that of the connection requesting device and is the lowest among all devices”. The disconnectable device identifying unit 15 determines whether the sum of the dynamic power consumptions at the time point Δt that will result, if the selected device is powered off, is less than the limit value. If the sum of the dynamic power consumptions is less than the limit value, the disconnectable device identifying unit 15 selects the selected device as the disconnectable device. The adjustment flag of the selected disconnectable device is turned on.

Step S19: If the sum of the dynamic power consumptions that will result if the disconnectable device selected at step S18 is powered off exceeds the limit value, the process returns to step S18, where another device is selected and the processing is repeated. If the sum of the dynamic power consumptions does not exceed the limit value, the process proceeds to step S13.

S110: If the rated power consumption in the connection requesting device is within the dynamic margin at step S11, an instruction to power on the connection requesting device is sent and then the process will end.

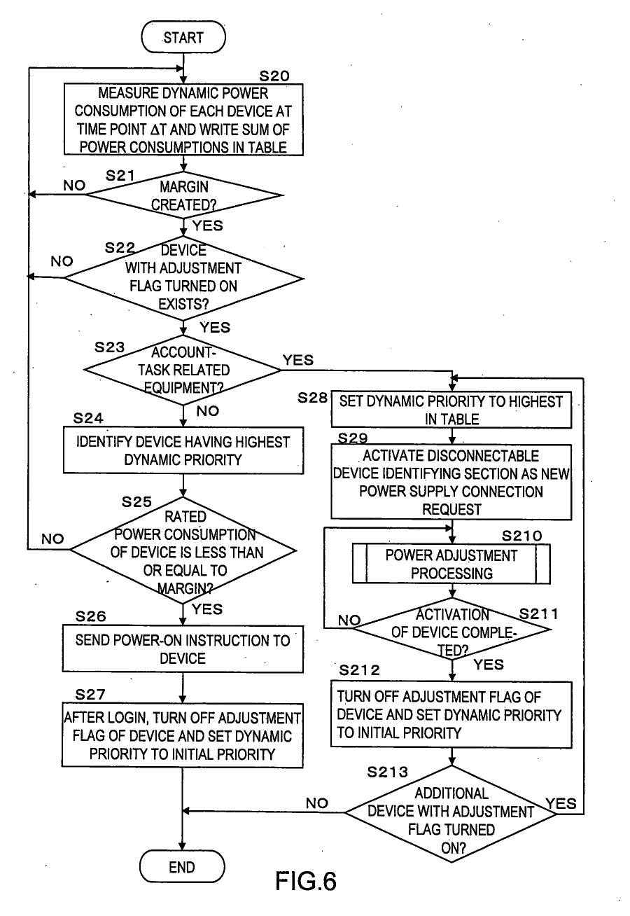

When a device is powered off in the subsequent power adjustment processing, restore adjustment processing is performed. FIG. 6 shows a flow of the restore adjustment processing.

Step S20: The dynamic power consumption measuring unit 11 measures the dynamic power consumptions of the servers 3a, 3b, and 3c at the predetermined time point Δt and writes them in the adjustment management table 100. The dynamic margin calculating unit 12 calculates the individual margin of each device in the adjustment management table 100 from the rated power consumption and the dynamic power consumption in the device and writes it in the adjustment management table 100.

Step S21: The connection restore adjusting unit 17 refers to the adjustment management table 100 to see whether a dynamic margin is created. If the dynamic margin is created, the process proceeds to step S21. If not, the process proceeds to steps S20.

Step S22: The connection restore adjusting unit 17 determines whether the adjustment management table 100 contains a device whose adjustment flag is set to on. If so, the process proceeds to step S23; otherwise, the process proceeds to step S20.

Step S23: The connection restore adjusting unit 17 refers to the equipment management table 120 to determine the device whose adjustment flag is turned on in the equipment management table 120 is equipment relating to account service business. If the device is account-service related equipment, the process proceeds to step S28; otherwise the process proceeds to step S24.

Step 24: The connection restore adjusting unit 17 identifies a device that has the highest dynamic priority in the adjustment management table 100.

Step S25: The connection restore adjusting unit 17 determines whether or not the rated power consumption in the identified device is less than or equal to the dynamic margin. If the rated power consumption in the device is less than or equal to the dynamic margin, the process proceeds to step S26.

Step S26: The connection restore adjusting unit 17 sends an instruction to power on the device.

Step S27: After confirming the log-in of the device, the connection restore adjusting unit 17 sets the adjustment flag of the device in the adjustment management table 100 to off and sets the dynamic priority to its initial priority, and then the process will end.

Step S28: The connection restore adjusting unit 17 sets the dynamic priority of the device to the highest in the adjustment management table 100.

Step S29: The connection restore adjusting unit 17 activates the disconnectable device identifying unit 15 as a request to connect a new device to the power supply.

Step S210: The power adjustment processing (steps S10 to S110) is performed by the disconnectable device identifying unit 15.

Step S211: The connection restore adjusting unit 17 confirms completion of activation of the device. After confirmation, the process proceeds to step S212.

Step S212: The connection restore adjusting unit 17 sets the adjustment flag of the device in the adjustment management table 100 to off and sets the dynamic priority to its initial priority.

Step S213: The connection restore adjusting unit 17 determines whether there is another device whose adjustment flag is set to on. If there is a device whose adjustment flag is set to on, the process returns to step S28; otherwise, the process will end.

While the present invention has been described with respect to an embodiment thereof, it will be understood that various variations of the present invention are possible without departing from the spirit and scope of the present invention.

It should be noted that when the power-on and power-off instructions mentioned in the embodiment are issued, the device or the server that controls the device power on or off the device using a known processing approach, the description of which is omitted herein.

What is claimed is:

1. An apparatus for adjusting a power consumption in a computer system regularly operated in a data center, comprising:
an adjustment management information memory unit for storing rated power consumptions of component devices of said computer system and an emergency device used for an irregular task in said data center and power supply priorities of said component devices;
a dynamic power consumption measuring unit for measuring a dynamic power consumption in each of said component devices at predetermined time intervals;
a dynamic margin calculating unit for calculating a dynamic margin at said time intervals by subtracting the sum of said dynamic power consumptions from a maximum value set as a maximum power amount allowed to be consumed in said data center;
a disconnectable device identifying unit for, when there is a request for connecting said emergency device to a power supply, comparing the rated power consumption in said emergency device with said dynamic margin, and, if the rated power consumption in said emergency device exceeds said dynamic margin, selecting as a disconnectable device a component device having a power amount obtained by subtracting the dynamic power consumption thereof from the rated power consumption is greater than a power amount by which said dynamic margin of the rated power consumption in said emergency device is exceeded and said priority thereof is the lowest from among said component devices; and
a device connection adjusting unit for, if the rated power consumption in said emergency device is less than or equal to said dynamic margin, sending an instruction to power on said emergency device: and, if the rated power consumption in said emergency device exceeds said dynamic margin, sending an instruction to power off said disconnectable device and, after confirming power-off of said disconnectable device, sending an instruction to power on said emergency device.

2. The power consumption adjusting apparatus according to claim 1, further comprising a connection restore adjusting unit for, if there is a component device among said component devices that is in a power-off state, comparing a dynamic margin obtained by subtracting the sum of the dynamic power consumptions of said component devices measured at a predetermined timing form said maximum value with the rated power consumption in said component device in the power-off state, selecting a component device in the power-off state the rated power consumption of which is less than or equal to said dynamic margin and said priority of which is the highest, and sending an instruction to power on said selected component device.

3. The power consumption adjusting apparatus according to claim 1, further comprising a dynamic priority calculating unit for, if said priority stored in said adjustment management information memory unit is represented by a power amount, calculating a dynamic priority of said component device by subtracting the difference between the rated power consumption and the dynamic power consumption from the priority of said component device,
wherein said disconnectable device identifying unit uses said dynamic priority instead of said priority to identify said disconnectable device.

4. The power consumption adjusting apparatus according to claim 1, wherein
said adjustment management information memory unit stores disconnection rejection information indicating a component device except said disconnectable device; and
said disconnectable device identifying unit identifies as said disconnectable device a component device for which said disconnection rejection information is not set.

5. A method for causing a computer to adjust a power consumption in a computer system regularly operated in a data center, comprising the steps of
measuring a dynamic power consumption in each of component devices at predetermined time intervals;
calculating a dynamic margin at said time intervals by subtracting the sum of said dynamic power consumptions from a maximum value set as a maximum power amount allowed to be consumed in said data center;
storing rated power consumptions of the component devices of said computer system and an emergency device used for an irregular task in said data center and power supply priorities of said component devices in an adjustment management information memory unit and, when there is a request for connecting said emergency device to a power supply, comparing the rated power consumption in said emergency device with said dynamic margin and, if the rated power consumption in said emergency device exceeds said dynamic margin, selecting as a disconnectable device a component device having a power amount obtained by subtracting the dynamic power consumption thereof from the rated power consumption is greater than a power amount by which said dynamic margin of the rated power consumption in said emergency device is exceeded and said priority thereof is the lowest from among said component devices; and
if the rated power consumption in said emergency device is less than or equal to said dynamic margin, sending an instruction to power on said emergency device and, if the rated power consumption in said emergency device exceeds said dynamic margin, sending an instruction to power off said disconnectable device and, after confirming power-off of said disconnectable device, sending an instruction to power on said emergency device.

6. A computer readable medium on which is recorded a power consumption adjusting apparatus program for adjusting a power consumption in a computer system regularly operated in a data center, said program causing a computer to function as a power consumption adjusting apparatus comprising:
an adjustment management information memory unit for storing rated power consumptions of component devices of said computer system and an emergency device used for an irregular task in said data center and power supply priorities of said component devices;
a dynamic power consumption measuring unit for measuring a dynamic power consumption in each of said component devices at predetermined time intervals;
a dynamic margin calculating unit for calculating a dynamic margin at said time intervals by subtracting the sum of said dynamic power consumptions from a maximum value established as a maximum power amount allowed to be consumed in said data center;
a disconnectable device identifying unit for, when there is a request for connecting said emergency device to a power supply, comparing the rated power consumption in said emergency device with said dynamic margin and, if the rated power consumption in said emergency device exceeds said dynamic margin, selecting as a disconnectable device a component device having a power amount obtained by subtracting the dynamic power consumption thereof from the rated power consumption is greater than a power amount by which said dynamic margin of the rated power consumption in said emergency device is exceeded and said priority thereof is the lowest from among said component devices; and
a device connection adjusting unit for, if the rated power consumption in said emergency device is less than or equal to said dynamic margin, sending an instruction to power on said emergency device and, if the rated power consumption in said emergency device exceeds said dynamic margin, sending an instruction to power off said disconnectable device and, after confirming power-off of said disconnectable device, sending an instruction to power on said emergency device.
